(19) United States
(12) Patent Application Publication
(10) Pub. No.: US 2008/0246703 A1
(43) Pub. Date: Oct. 9, 2008

(54) Display Driving Methods and Apparatus for Driving a Passive Matrix Multicolor Electroluminescent Display

(75) Inventor: Euan C. Smith, Cambridgeshire (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: CAMBRIDGE DISPLAY TECHNOLOGY LIMITED, Cambridgeshire (GB)

(21) Appl. No.: 12/063,979

(22) PCT Filed: Aug. 9, 2006
(86) PCT No.: PCT/GB2006/002961

§ 371 Date: Jun. 18, 2008

(30) Foreign Application Priority Data
Aug. 23, 2005 (GB) 0517215.0

(51) Int. Cl. G09G 3/30

(52) U.S. Cl. 345/80

(57) ABSTRACT

A method of driving a passive matrix multicolor electroluminescent display, the display comprising a plurality of pixels arranged in rows and columns, each said pixel comprising at least first and second sub-pixels having different respective first and second colors, the method comprising: driving groups of said pixels in turn to display a multicolor image frame, said driving of a group of pixels comprising driving first and second sub-groups of sub-pixels of respective said first and second colors; and wherein said driving further comprises driving a said group of pixels for a duration dependent upon a maximum drive level of a sub-pixel of a said sub-group.

This invention is generally concerned with apparatus, methods and computer program code for driving electroluminescent displays, in particular organic light emitting diode (OLED) displays.

### Organic Light Emitting Diode Displays

Organic light emitting diodes, which here include organometallic LEDs, may be fabricated using materials including polymers, small molecules and dendrimers, in a range of colours which depend upon the materials employed. Examples of polymer-based organic LEDs are described in WO 90/13148, WO 95/06400 and WO 99/48160; examples of dendrimer-based materials are described in WO 99/21935 and WO 02/067343; and examples of so called small molecule based devices are described in U.S. Pat. No. 4,539,507. A typical OLED device comprises two layers of organic material, one of which is a layer of light emitting material such as a light emitting polymer (LEP), oligomer or a light emitting low molecular weight material, and the other of which is a layer of a hole transporting material such as a polythiophene derivative or a polyaniline derivative.

Organic LEDs may be deposited on a substrate in a matrix of pixels to form a single or multi-colour pixellated display. A multicoloured display may be constructed using groups of red, green, and blue emitting sub-pixels. So-called active matrix displays have a memory element, typically a storage capacitor and a transistor, associated with each pixel whilst passive matrix displays have no such memory element and instead are repetitively scanned to give the impression of a steady image. Other passive displays include segmented displays in which a plurality of segments share a common electrode and a segment may be lit up by applying a voltage to its other electrode. A simple segmented display need not be scanned but in a display comprising a plurality of segmented regions the electrodes may be multiplexed (to reduce their number) and then scanned.

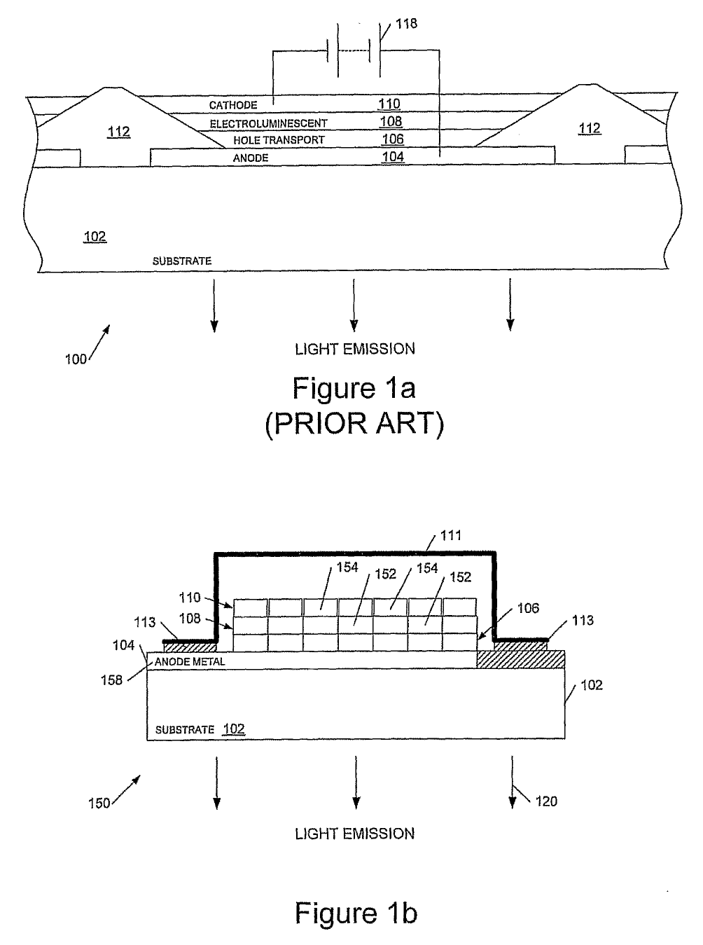

FIG. 1a shows a vertical cross section through an example of an OLED device 100. In an active matrix display part of the area of a pixel is occupied by associated drive circuitry (not shown in FIG. 1a). The structure of the device is somewhat simplified for the purposes of illustration.

The OLED 100 comprises a substrate 102, typically 0.7 mm or 1.1 mm glass but optionally clear plastic or some other substantially transparent material. An anode layer 104 is deposited on the substrate, typically comprising around 150 nm thickness of ITO (indium tin oxide), over part of which is provided a metal contact layer. Typically the contact layer comprises around 500 nm of aluminium, or a layer of aluminium sandwiched between layers of chrome, and this is sometimes referred to as anode metal. Glass substrates coated with ITO and contact metal are available from Corning, USA. The contact metal over the ITO helps provide reduced resistance pathways where the anode connections do not need to be transparent, in particular for external contacts to the device. The contact metal is removed from the ITO where it is not wanted, in particular where it would otherwise obscure the display, by a standard process of photolithography followed by etching.

A substantially transparent hole transport layer 106 is deposited over the anode layer, followed by an electroluminescent layer 108, and a cathode 110. The electroluminescent layer 108 may comprise, for example, a PPV (poly(p-phenylenevinylene)) and the hole transport layer 106, which helps match the hole energy levels of the anode layer 104 and electroluminescent layer 108, may comprise a conductive transparent polymer, for example PEDOT:PSS (polystyrene-sulphonate-doped polyethylene-dioxythiophene) from Bayer AG of Germany. In a typical polymer-based device the hole transport layer 106 may comprise around 200 nm of PEDOT; a light emitting polymer layer 108 is typically around 70 nm in thickness. These organic layers may be deposited by spin coating (afterwards removing material from unwanted areas by plasma etching or laser ablation) or by inkjet printing. In this latter case banks 112 may be formed on the substrate, for example using photoresist, to define wells into which the organic layers may be deposited. Such wells define light emitting areas or pixels of the display.

Cathode layer 110 typically comprises a low work function metal such as calcium or barium (for example deposited by physical vapour deposition) covered with a thicker, capping layer of aluminium. Optionally an additional layer may be provided immediately adjacent the electroluminescent layer, such as a layer of barium fluoride, for improved electron energy level matching. Mutual electrical isolation of cathode lines may be achieved or enhanced through the use of cathode separators (not shown in FIG. 1a).

The same basic structure may also be employed for small molecule and dendrimer devices. Typically a number of displays are fabricated on a single substrate and at the end of the fabrication process the substrate is scribed, and the displays separated before an encapsulating can is attached to each to inhibit oxidation and moisture ingress.

To illuminate the OLED power is applied between the anode and cathode, represented in FIG. 1a by battery 118. In the example shown in FIG. 1a light is emitted through transparent anode 104 and substrate 102 and the cathode is generally reflective; such devices are referred to as “bottom emitters”. Devices which emit through the cathode (“top emitters”) may also be constructed, for example by keeping the thickness of cathode layer 110 less than around 50-100 nm so that the cathode is substantially transparent.

It will be appreciated that the foregoing description is merely illustrative of one type of OLED display, to assist in understanding some applications of embodiments of the invention. There is a variety of other types of OLED, including reverse devices where the cathode is on the bottom such as those produced by Novaled GmbH. Moreover application of embodiments of the invention are not limited to displays, OLED or otherwise.

Organic LEDs may be deposited on a substrate in a matrix of pixels to form a single or multi-colour pixellated display. A multicoloured display may be constructed using groups of red, green, and blue emitting pixels. In such displays the individual elements are generally addressed by activating row (or column) lines to select the pixels, and rows (or columns) of pixels are written to, to create a display. So-called active matrix displays have a memory element, typically a storage capacitor and a transistor, associated with each pixel whilst passive matrix displays have no such memory element and instead are repetitively scanned, somewhat similarly to a TV picture, to give the impression of a steady image.

Referring now to FIG. 1b, this shows a simplified cross-section through a passive matrix OLED display device 150, in which like elements to those of FIG. 1a are indicated by like reference numerals. As shown the hole transport 106 and electroluminescent 108 layers are subdivided into a plurality of pixels 152 at the intersection of mutually perpendicular anode and cathode lines defined in the anode metal 104 and cathode layer 110 respectively. In the figure conductive lines 154 defined in the cathode layer 110 run into the page and a cross-section through one of a plurality of anode lines 158 running at right angles to the cathode lines is shown. An electroluminescent pixel 152 at the intersection of a cathode and anode line may be addressed by applying a voltage between the relevant lines. The anode metal layer 104 provides external contacts to the display 150 and may be used for both anode and cathode connections to the OLEDs (by running the cathode layer pattern over anode metal lead-outs). The above mentioned OLED materials, in particular the light emitting polymer and the cathode, are susceptible to oxidation and to moisture and the device is therefore encapsulated in a metal can 111, attached by UV-curable epoxy glue 113 onto anode metal layer 104, small glass beads within the glue preventing the metal can touching and shorting out the contacts.

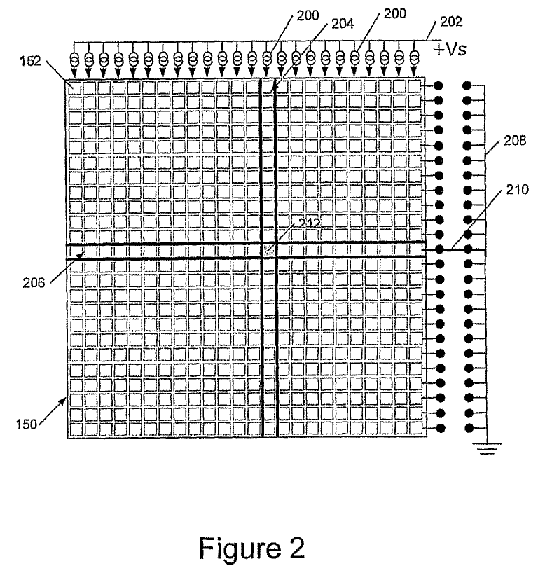

Referring now to FIG. 2, this shows, conceptually, a driving arrangement for a passive matrix OLED display 150 of the type shown in FIG. 1b. A plurality of constant current generators 200 are provided, each connected to a supply line 202 and to one of a plurality of column lines 204, of which for clarity only one is shown. A plurality of row lines 206 (of which only one is shown) is also provided and each of these may be selectively connected to a ground line 208 by a switched connection 210. As shown, with a positive supply voltage on line 202, column lines 204 comprise anode connections 158 and row lines 206 comprise cathode connections 154, although the connections would be reversed if the power supply line 202 was negative and with respect to ground line 208.

As illustrated pixel 212 of the display has power applied to it and is therefore illuminated. To create an image connection 210 for a row is maintained as each of the column lines is activated in turn until the complete row has been addressed, and then the next row is selected and the process repeated. Preferably, however, to allow individual pixels to remain on for longer and hence reduce overall drive level, a row is selected and all the columns written in parallel, that is a current driven onto each of the column lines simultaneously to illuminate each pixel in a row at its desired brightness. Each pixel in a column could be addressed in turn before the next column is addressed but this is not preferred because, inter alia, of the effect of column capacitance.

The skilled person will appreciate that in a passive matrix OLED display it is arbitrary which electrodes are labelled row electrodes and which column electrodes, and in this specification “row” and “column are used interchangeably.

It is usual to provide a current-controlled rather than a voltage-controlled drive to an OLED because the brightness of an OLED is determined by the current flowing through the device, this determining the number of photons it generates. In a voltage-controlled configuration the brightness can vary across the area of a display and with time, temperature, and age, making it difficult to predict how bright a pixel will appear when driven by a given voltage. In a colour display the accuracy of colour representations may also be affected.

The conventional method of varying pixel brightness is to vary pixel on-time using Pulse Width Modulation (PWM). In a conventional PWM scheme a pixel is either full on or completely off but the apparent brightness of a pixel varies because of integration within the observer's eye. An alternative method is to vary the column drive current.

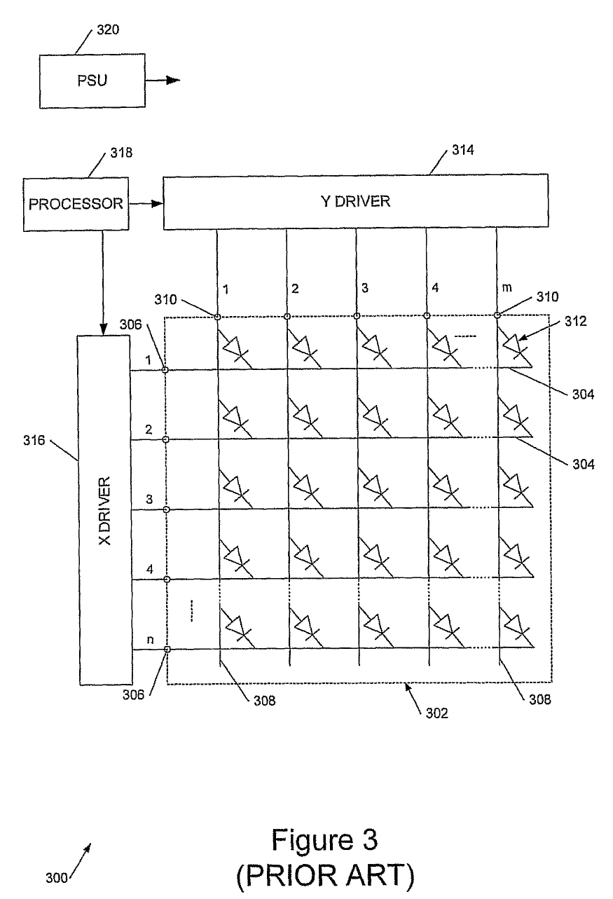

FIG. 3 shows a schematic diagram 300 of a generic driver circuit for a passive matrix OLED display according to the prior art. The OLED display is indicated by dashed line 302 and comprises a plurality n of row lines 304 each with a corresponding row electrode contact 306 and a plurality m of column lines 308 with a corresponding plurality of column electrode contacts 310. An OLED is connected between each pair of row and column lines with, in the illustrated arrangement, its anode connected to the column line. A y-driver 314 drives the column lines 308 with a constant current and an x-driver 316 drives the row lines 304, selectively connecting the row lines to ground. The y-driver 314 and x-driver 316 are typically both under the control of a processor 318. A power supply 320 provides power to the circuitry and, in particular, to y-driver 314.

Some examples of OLED display drivers are described in U.S. Pat. No. 6,014,119, U.S. Pat. No. 6,201,520, U.S. Pat. No. 6,332,661, EP 1,079,361A and EP 1,091,339A and OLED display driver integrated circuits employing PWM are sold by Clare Micronix of Clare, Inc., Beverly, Mass., USA. Some examples of improved OLED display drivers are described in the Applicant's co-pending applications WO 03/079322 and WO 03/091983. In particular WO 03/079322, hereby incorporated by reference, describes a digitally controllable programmable current generator with improved compliance.

### SUMMARY OF THE INVENTION

There is a general need to improve the lifetime and/or power consumption of OLED displays. In particular, in multicolour OLED displays the red, green and blue-emitting materials used for the sub-pixels of the display in general have different efficiencies and age at different rates, normally blue sub-pixels ageing faster than red and green sub-pixels. There is therefore a need for improved techniques for driving OLED displays to mitigate these problems.

According to a first aspect of the present invention there is therefore provided a method of driving a passive matrix multicolour electroluminescent display, the display comprising a plurality of pixels arranged in rows and columns, each said pixel comprising at least first and second sub-pixels having different respective first and second colours, the method comprising: driving groups of said pixels in turn to display a multicolour image frame, said driving of a group of pixels comprising driving first and second sub-groups of sub-pixels of respective said first and second colours; and wherein said driving further comprises driving a said group of pixels for a duration dependent upon a maximum drive level of a sub-pixel of a said sub-group.

The groups of pixels may comprise lines of pixels corresponding to rows or columns of the display in a conventional line-scanned passive matrix OLED display, or the groups of pixels may comprise temporal sub-frames with a variable display duration in a display driven according to a multi-line or “total matrix” addressing (MLA or TLA) scheme such as has previously been described in the applicant's UK Patent Applications, for example, No. 0501211.7 (priority date 30 Sep. 2004) and 0428191.1 (filing date 23 Dec. 2004) the contents of which are hereby incorporated in their entirety by reference.

In some preferred embodiments the duration is dependent upon a maximum drive level of a sub-pixel of a single colour sub-group, for example the sub-group of blue sub-pixels of each group of pixels. Thus the driving of groups of pixels to display an image frame preferably comprises driving over a frame period comprising, for example, a set of line scan intervals or a set of sub-frame display intervals. The frame period may then be divided into periods for driving each group of pixels, such as each line or temporal sub-frame, in proportion to the maximum drive level of the selected sub-group (for example the blue-group) for each group of pixels. The driving may then comprise driving the group of pixels according to these frame period divisions.

Such embodiments help to reduce the ageing of the most sensitive pixel elements, typically the blue sub-pixels, thereby helping to extend the life of the whole display. Broadly speaking, if a given group of pixels (line or sub-frame) has a reduced peak luminence for a particular colour, say blue, then this group of pixels may be driven for a relatively shorter time whereas a group of pixels with a high peak luminescence for, say, blue is driven for longer. In this way, to the eye of a human observer the level of blue luminance is still substantially that desired but this has been achieved by using a lower peak luminance for a longer duration by, in effect, adjusting or averaging the durations for which the groups of pixels are driven, within a frame period.

The above techniques are particularly useful for increasing the lifetime of blue sub-pixels. However embodiments of the method may also be applied for other purposes—for example red sub-pixels tend to have a reduced efficiency at higher luminences and therefore by applying similar techniques (scaling the on-time of a group of pixels according to peak luminance) the overall power consumption of a display can be reduced.

In other, related embodiments the duration for which a group of pixels is driven is dependent upon a weighted combination of the maximum drive level for a plurality of sub-pixels—for example a weighted combination of a maximum drive level of a sub-group of red sub-pixels and/or a maximum drive level of a sub-group of green sub-pixels and/or a maximum drive level of a sub-group of blue sub-pixels. Thus, in a similar way to that described above, a frame period may be divided in proportion to a weighted combination and the groups of pixels driven accordingly.

In the above embodiments the drive to one or more sub-groups of sub-pixels may be adjusted responsive to the determined duration for driving the sub-group. This may conveniently be achieved by adjusting a reference level, such as a reference current source common to a set of sub-pixels such as a red and/or green and/or blue current or voltage reference. Thus, for example, the reference level for a sub-group of sub-pixels can be reduced in proportion to an increase in drive duration for the group of pixels comprising the sub-group (reduced/increased as compared with, for example, a norm defined by equal drive durations for each group of pixels). Thus, preferably, the drive, or more particularly reference level, for each of the three colours is adjusted on a group-by-group (line or sub-frame) basis to compensate for adjustments in the pixel group drive duration.

In preferred embodiments of the above described method the multicolour electroluminescent display comprises an OLED display.

The invention further provides a carrier medium carrying processor control code to implement the above described methods and display drivers. This code may comprise conventional program code, for example source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). Such code may be distributed between a plurality of coupled components. The carrier medium may comprise any conventional storage medium such as a disk or programmed memory (for example firmware such as Flash RAM or ROM), or a data carrier such as an optical or electrical signal carrier.

The invention further provides a display driver comprising means for implementing embodiments of display driving methods as described above.

Thus in a related aspect the invention provides a driver for a passive matrix multicolour electroluminescent display, the display comprising a plurality of pixels arranged in rows and columns, each said pixel comprising at least first and second sub-pixels having different respective first and second colours, the driver comprising: means for driving groups of said pixels in turn to display a multicolour image frame, said driving of a group of pixels comprising driving first and second sub-groups of sub-pixels of respective said first and second colours; and means for driving a said group of pixels for a duration dependent upon a maximum drive level of a sub-pixel of a said sub-group.

In a further related aspect the invention provides a driver for passive matrix multicolour electroluminescent display, the display comprising a plurality of pixels arranged in rows and columns, each said pixel comprising at least first and second sub-pixels having different respective first and second colours, the driver comprising: a data input to receive image data for display; a display drive system, coupled to said data input and having a display drive output for driving said display, said display drive system being configured to output display drive signals for driving groups of said pixels in turn to display a multicolour image frame, said driving of a group of pixels comprising driving first and second sub-groups of sub-pixels of respective said first and second colours; and a drive time computation system, coupled to said display drive system, said drive time computation system being configured to control said display drive system to drive a said group of pixels for a duration dependent upon a maximum drive level of a sub-pixel of a said sub-group.

In another aspect the invention provides a method of driving an electroluminescent display having a plurality of pixels arranged in rows and columns, the method comprising driving the display with successive sets of row and column signals to build up a displayed image, each set of signals defining a sub-frame of the displayed image in which pixels in a plurality of rows and columns of the display are driven simultaneously, the sub-frames combining to create said displayed image, the method further comprising driving said display with a said set of signals for a sub-frame for a duration dependent upon a maximum drive level of a pixel of the sub-frame.

In embodiments one sub-frame is employed per colour of a multicolour OLED display.

In a related aspect the invention provides a driver for driving an electroluminescent display having a plurality of pixels arranged in rows and columns, the driver comprising: a data input to receive image data for display; a display drive system, coupled to said data input and having a display drive output for driving said display, said display drive system being configured to output display drive signals for driving the display with successive sets of row and column signals to build up a displayed image, each set of signals defining a sub-frame of the displayed image in which pixels in a plurality of rows and columns of the display are driven simultaneously, the sub-frames combining to create said displayed image; and a drive time computation system, coupled to said display drive system, said drive time computation system being configured to control said display drive system to drive said display with a said set of signals for a sub-frame for a duration dependent upon a maximum drive level of a pixel of the sub-frame.

These and other aspects of the invention will now be further described, by way of example only, with reference to the accompanying figures in which:

FIGS. 1a and 1b show, respectively, a vertical cross section through an OLED device, and a simplified cross section through a passive matrix OLED display;

FIG. 2 shows conceptually a driving arrangement for a passive matrix OLED display;

FIG. 3 shows a block diagram of a known passive matrix OLED display driver;

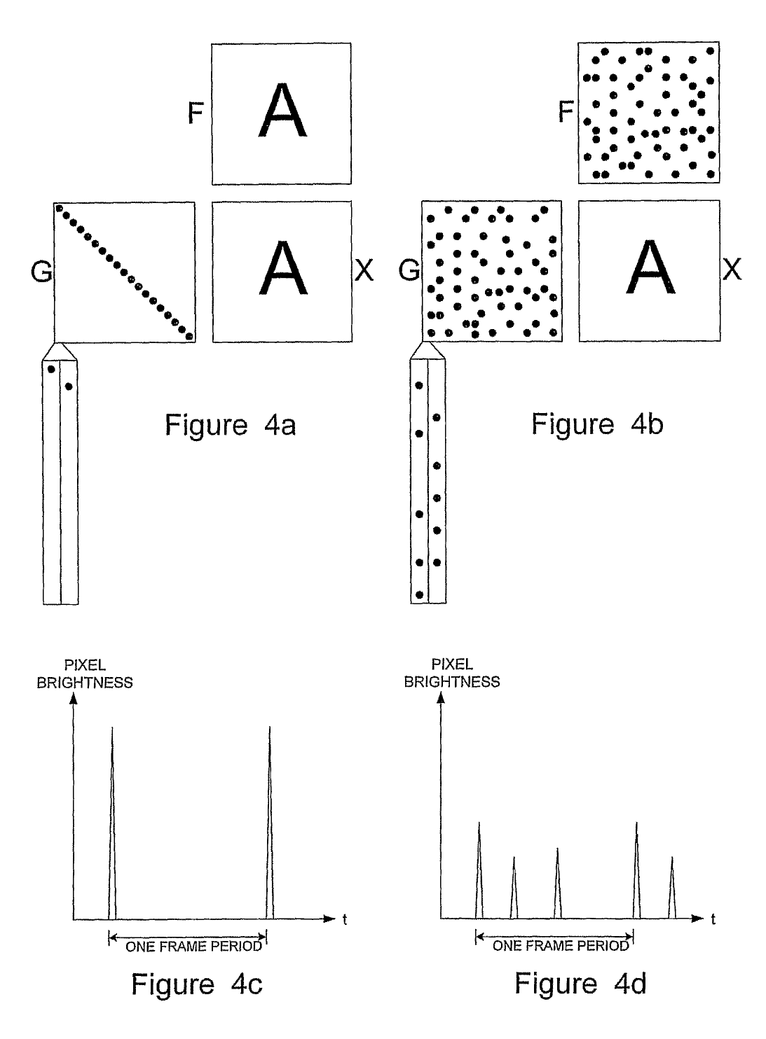

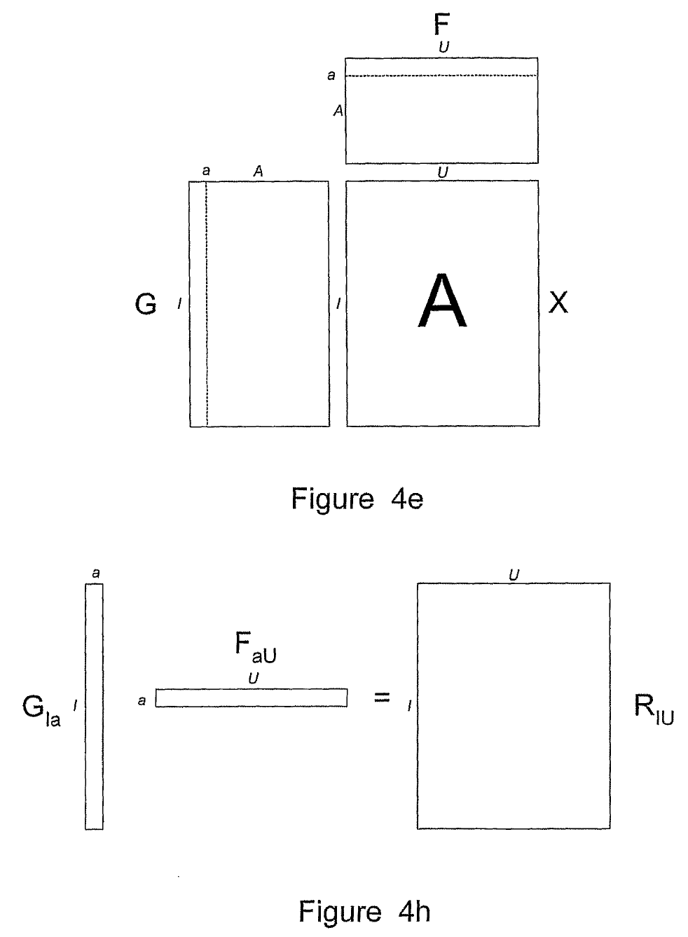

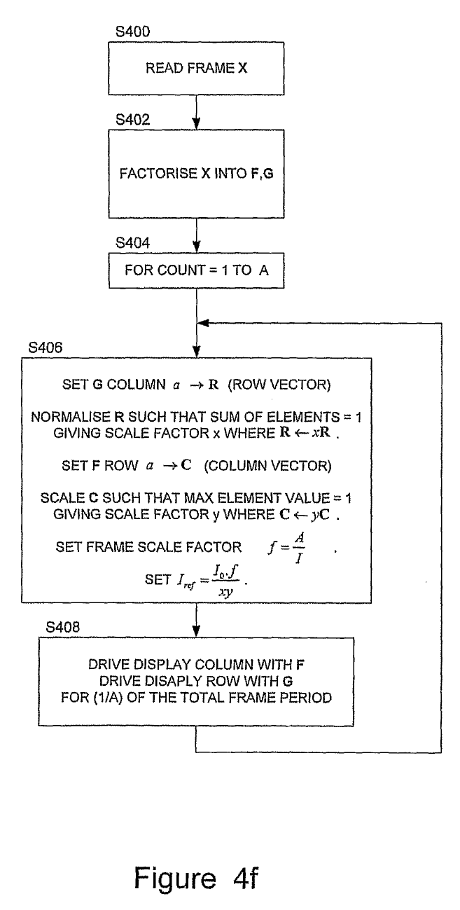

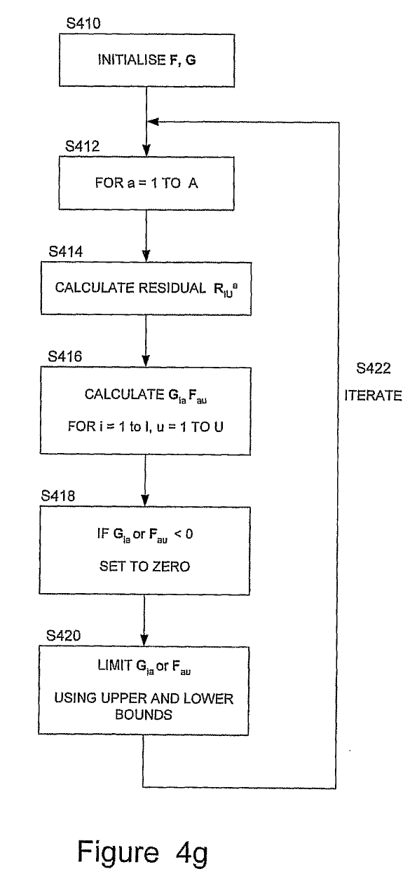

FIGS. 4a to 4h show, respectively, row, column and image matrices and corresponding brightness curves for a typical pixel over a frame period for a conventional drive scheme; row, column and image matrices and corresponding brightness curves for a typical pixel over a frame period for a multiline addressing drive scheme; a diagrammatic representation of NMF factorisation of an image matrix; a flow diagram of a method of driving a display using image matrix factorisation; a flow diagram of an NMF procedure; and multiplication of a selected column and row of the G and F matrices of FIG. 4e to determine a residual matrix; and

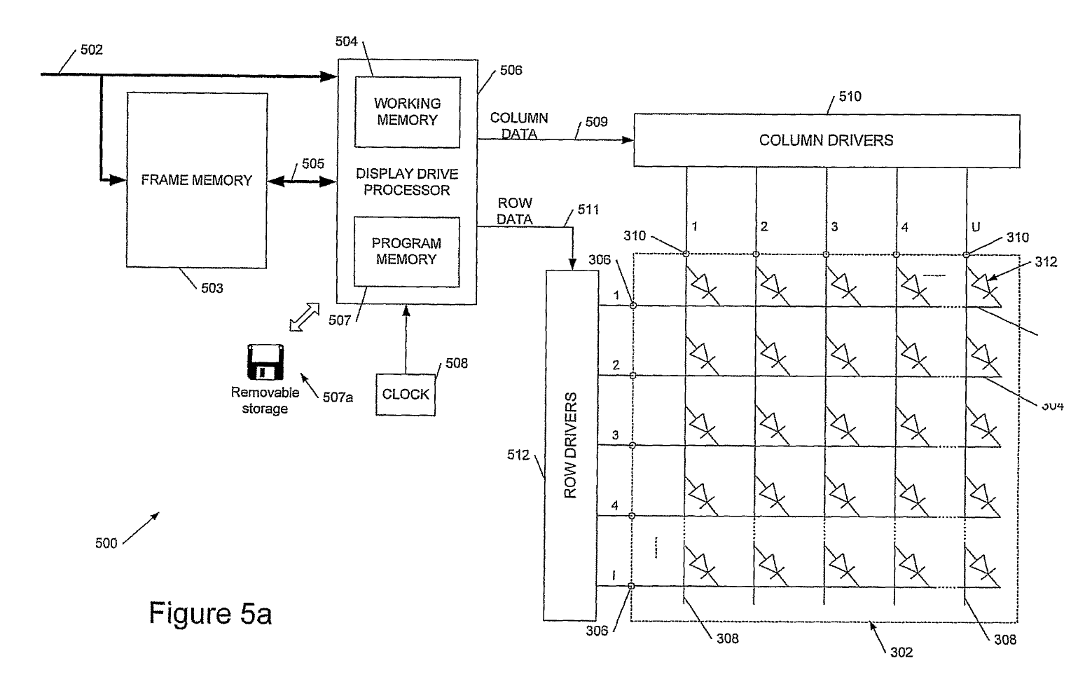

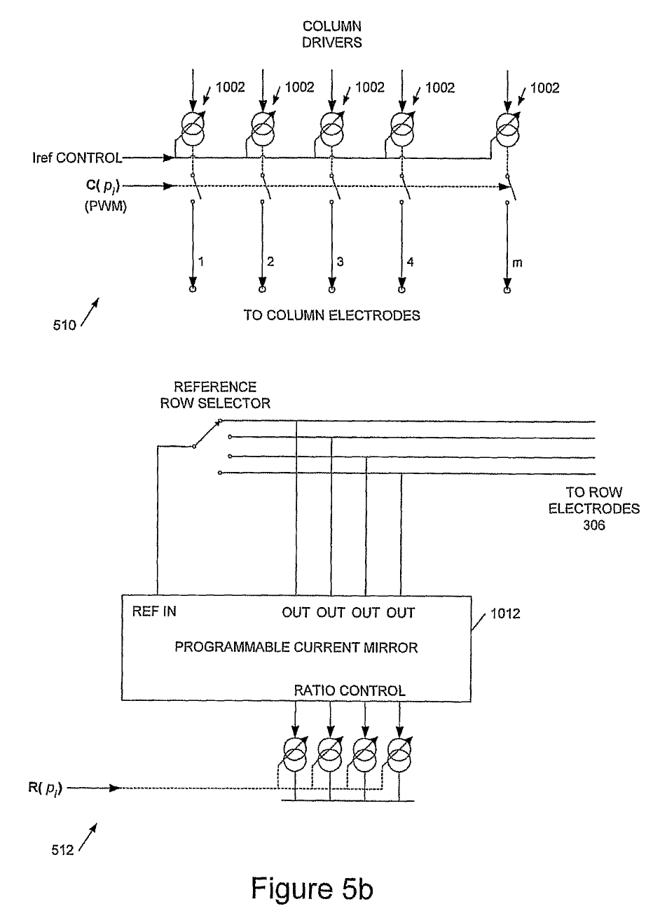

FIGS. 5a and 5b show, respectively, a display driver embodying an aspect of the present invention, and example column and row drive arrangements for driving a display using the matrices of FIG. 4e.

### Multi Line Addressing (MLA) Techniques

It is helpful, for understanding embodiments of the invention, to outline Multi Line Addressing (MLA) techniques.

Broadly speaking MLA techniques drive two or more row electrodes at the same time as the column electrodes are driven, or more generally drive groups of rows and columns simultaneously, so that the required luminescence profile of each row (line) is built up over a plurality of line scan periods rather than as an impulse in a single line scan period. Thus the pixel drive during each line scan period can be reduced, hence extending the lifetime of the display and/or reducing the power consumption due to a reduction of drive voltage and reduced capacitive losses. This is because OLED lifetime reduces with the pixel drive (luminance) to a power typically between 1 and 2 but the length of time for which a pixel must be driven to provide the same apparent brightness to an observer increases only substantially linearly with decreasing pixel drive. The degree of benefit provided by MLA depends in part upon the correlation between the groups of lines driven together. The applicant refers to arrangements where all the rows are driven together as total matrix addressing techniques.

FIG. 4a shows row G, column F and image X matrices for a conventional drive scheme in which one row is driven at a time. FIG. 4b shows row, column and image matrices for a multiline addressing scheme. FIGS. 4c and 4d illustrate, for a typical pixel of the displayed image, the brightness of the pixel, or equivalently the drive to the pixel, over a frame period, showing the reduction in peak pixel drive which is achieved through multiline addressing.

Generally the row and column drive signals are selected such that a desired luminescence of OLED pixels (or sub-pixels) driven by the corresponding electrodes is obtained by a substantially linear sum of luminescences determined by the drive signals. We have previously described (UK patent application no 0421711.3 filed 30 Sep. 2004) a controllable current divider to divide column current drive signals between two or more rows in accordance with the determined row drive signals.

To determine the required drive signals image data for display may be considered as a matrix and factorised into a product of two factor matrices, one defining row drive signals, the other column drive signals. The display is driven with successive sets of row and column signals, as defined by these matrices, to build up a displayed image, each set of signals defining a sub-frame of the displayed image the same size as the originally factorised matrix. The total number of line scan periods (sub-frames) may but need not necessarily be reduced compared with a conventional line-by-line scan (reduction implying image compression), since some benefit is obtained merely by averaging out the brightness over a number of sub-frames.

Preferably non-negative matrix factorisation (NMF) is employed, in which the image matrix X (which is non-negative) is factorised into a pair of matrices F and G such that X is approximately equal to the product of F and G, F and G being chosen subject to the constraint that their elements are all equal to or greater than zero. A typical NMF algorithm iteratively updates F and G to improve the approximation by aiming to minimise a cost function such as the squared Euclidean distance between X and FG. Non-negative matrix factorisation is useful for driving an electroluminescent display as such a display cannot be driven to produce a “negative” luminescence.

A NMF factorisation procedure is diagrammatically illustrated in FIG. 4e. The matrices F and G can be regarded as defining a basis for the linear approximation of the image data and in many cases a good representation of can be achieved with a relatively small number of basis vectors since images generally contain some inherent, correlated structure rather than purely random data. The colour sub-pixels of a colour display may be treated as three separate image planes or together as a single plane. Sorting the data in the factor matrices so that bright areas of a displayed image are generally illuminated in a single direction, from top to bottom of the display, can reduce flicker.

FIG. 4f shows a flow diagram of an example procedure for displaying an image using NMF. The procedure first reads the frame image matrix X (step S400), and then factorises this image matrix into factor matrices F and G using NMF (step S402). This factorisation may be computed during display of an earlier frame. The procedure then drives the display with A sub-frames at step 404. Step 406 shows the sub-frame drive procedure.

The sub-frame procedure sets G-column a→R to form a row vector R. This is automatically normalised to unity by the row driver arrangement of FIG. 5b and a scale factor x, R←xR is therefore derived by normalising R such that the sum of elements is unity. Similarly with F, row a→C to form a column vector C. This is scaled such that the maximum element value is 1, giving a scale factor y, C←yC. The a frame scale factor

$$f = \frac{A}{I}$$

is determined and the reference current set by

$${I}_{ref} = \frac{{I}_{0} \cdot f}{xy}$$

where I₀ corresponds to the current required for full brightness in a conventionally scanned line-at-a-time system, the x and y factors compensating for scaling effects introduced by the driving arrangement (with other driving arrangements one or both of these may be omitted).

Following this, at step S408, the display drivers shown in FIG. 5b drive the columns of the display with C and rows of the display with R for 1/A of the total frame period. This is repeated for each sub-frame and the sub-frame data for the next frame is then output.

Referring to FIG. 4g, an example NMF procedure begins by initialising F and G (step S410) so that the product of G and F is equal to the average value of X, X_{average}, as follows:

G=1_{1A}F=(X_{average}/A)·1_{AU} (1)

For a sequence of related images previously found values of F and G may be used. The subscripts indicate number of rows and columns respectively; lower case subscripts indicate a single selected row or column (eg a for one of A rows); 1 is the unity matrix.

Preferably, as a pre-processing step (not shown) prior to step S410, blank rows and columns are filtered out.

The overall aim of the procedure is to determine values for F and G such that:

G_{IA}F_{AU}=X_{IU} (2)

The procedure we describe operates with a single column (a) of G and a single row (a) of F at a time, stepping through all the column-row pairs, from a=1 to a=A (step S412). Thus the procedure, for each column of G and row of F, first calculates a residual R_{IU}^{a} for the selected column-row pair, this residual comprising a difference between the target X_{IU} and a sum of the combined contributions of all the other columns and rows of G and F except for the selected column/row (step S414):

$${R}_{IU}^{a} = {X}_{IU} - {\sum }_{n = 1}^{A , n \neq a} {G}_{In} {F}_{nU} \qquad ( 3 )$$

For each selected column-row pair a of G and F the aim is for the contribution of the selected column-row pair to equal the residual R_{IU}^{a}, as illustrated diagrammatically in FIG. 4h. In mathematical terms the aim is:

G_{Ia}F_{aU}=R_{IU}^{a} (4)

where R_{IU}^{a} defines an I×U image sub-frame with mux rate A (A sub-frames contributing to a complete I×U displayed image).

Equation (4) can be solved for each of the I elements Gᵢₐ of the selected column a of G and for each of the U elements Fₐᵤ of the selected row a of F (step S416). The solution depends upon the cost function. For example, performing a least squares fit (a Euclidean cost function) on (4) multiplies the left hand side by F_{aU}.F^{T}_{aU} (which is a scalar value, so that no matrix inversion is required to divide both sides by this) and multiplies the right hand side by F^{T}_{aU}, allowing Gᵢₐ to be calculated directly.

An example solution for a Euclidean cost function is as follows:

$${G}_{ia} = \frac{{\sum }_{u = 1}^{U} {R}_{iu} {F}_{au}}{{\sum }_{u = 1}^{U} {F}_{au}^{2}} , {F}_{au} = \frac{{\sum }_{i = 1}^{I} {G}_{ia} {R}_{iu}}{{\sum }_{i = 1}^{I} {G}_{ia}^{2}} \qquad ( 5 )$$

To provide a non-negativity constraint, values of Gᵢₐ and Fₐᵤ which are less than zero are set to zero (or a small value), at step S418 (elements of R_{IU}^{a} are permitted to be negative).

Preferably (but not essentially), to prevent division by zero (or infinite) values of Gᵢₐ and Fₐᵤ may be limited by upper and/or lower bounds of, for example, 0.01 or 0.001 and 10 or 100; these may be varied according to the application (step S420).

Optionally but preferably the procedure then iterates (step S422), for example for a predetermined number of iterations.

For further details reference may be made to UK patent application no. 0428191.1 filed on 23 Dec. 2004.

### Colour Lifetime Balanced Variable Scan Time Driving

In one variable scan time drive technique the line or sub-frame scan time is proportional to the peak luminence of a sub-pixel irrespective of colour. This reduces the worst case peak drive level and thus extends the life of the display. However in a development of this technique the line or sub-frame scan time is determined by or proportional to the luminance of the most (ageing) sensitive colour pixel element, the aim being to minimise the ageing of the worst case sub-pixel. In embodiments different colour weighting factors may be employed for each sub-pixel so that the line or sub-frame scan time is determined by

x.max{R}+y.max{G}+z.max{B}

where the weighting factors x, y, z of the respective sub-pixel drive levels R, G, B may be determined by the ageing experienced by a sub-pixel colour and/or efficiency of a sub-pixel colour (where a reduction in power consumption is paramount).

Alternatively some other weighted combination such as

max{xR+yG+zB}

may be employed.

In embodiments, if all colours are equally sensitive the colour weighting factors are the same and effectively cancel each other out. However for very sensitive blues, for example, the weighting factor for the blue sub-pixel will dominate and the line or sub-frame times will be largely influenced by the blue sub-pixel luminence. For a particular combination of blue, red and green materials the optimum multiplication factors (which may be determined, for example, by routine experimentation) may be pre-programmed into the drive controller with the aim of minimising ageing. The reference current for each colour may be changed on a line-by-line or sub-frame-by-sub-frame basis, for example to scale the drive so that the peak drive current for a line or sub-frame is substantially the same for all lines or sub-frames (for a given colour). Thus preferred embodiments of the techniques operate in the context of a system in which separate current drive references are provided for red, green and blue sub-pixels.

In an embodiment the line or sub-frame time may be scaled proportional to the peak blue luminence present during a line or sub-frame as follows:

$${t}_{line . or . subframe} = \frac{{lum}_{max , blue}}{{\sum }_{lines . or . subframes} {lum}_{max , blue}} \cdot ( total . time . for . lines . or . subframes )$$

alternatively this equation may be modified to scale line or sub-frame times to be proportional to peak luminence multiplied by a weighting factor dependent upon pixel colour.

Table 1 below shows an example in which the numbers represent peak luminences for each colour (red, green, blue) for a series of hypothetical frames.

TABLE 1

| R | G | B |
|---|---|---|
| 0.2 | 0.5 | 1.0 |
| 0.4 | 1.0 | 0.5 |
| 1.0 | 0.9 | 0.9 |

For equal time scanning each sub-frame is allocated one-third of the total (frame) time and blue ageing is proportional to:

0.0̂2*1/3+0.5̂2*1/3+0.9̂2*1/3=0.686

However for colour weighted scanning if, say, the blue luminences dominate due to a high weighting then the sub-frame times for the three sub-frames are as shown in table 2 below:

TABLE 2

| R | G | B | t |
|---|---|---|---|
| 0.2 | 0.5 | 1.0 | 1.0/2.4 |
| 0.4 | 1.0 | 0.5 | 0.5/2.4 |
| 1.0 | 0.9 | 0.9 | 0.9/2.4 |

In this case the blue ageing is proportional to:

((1.0+0.5+0.9)/3.0)̂2=0.64

Thus it can be seen that, in this example, the ageing of the blue sub-pixels is reduced by approximately seven percent.

FIG. 5a shows a schematic diagram of an embodiment of a passive matrix OLED driver 500 suitable for implementing embodiments of the invention.

In FIG. 5a a passive matrix OLED display similar to that described with reference to FIG. 3 has row electrodes 306 driven by row driver circuits 512 and column electrodes 310 driven by column drives 510. Details of these row and column drivers are shown in FIG. 5b. Column drivers 510 have a column data input 509 for setting the current drive to one or more of the column electrodes and for controlling the red/green/blue reference currents; similarly row drivers 512 have a row data input 511 for setting the current drive to a row and, in an MLA embodiment, for setting the current drive ratio to two or more of the rows. Preferably inputs 509 and 511 are digital inputs for ease of interfacing; preferably column data input 509 sets the current drives for all the U columns of display 302.

Data for display is provided on a data and control bus 502, which may be either serial or parallel. Bus 502 provides an input to a frame store memory 503 which stores luminance data for each pixel of the display or, in a colour display, luminance information for each sub-pixel (which may be encoded as separate RGB colour signals or as luminance and chrominance signals or in some other way). The data stored in frame memory 503 determines a desired apparent brightness for each pixel (or sub-pixel) for the display, and this information may be read out by means of a second, read bus 505 by a display drive processor 506 (in embodiments bus 505 may be omitted and bus 502 used instead).

Display drive processor 506 may be implemented entirely in hardware, or in software using, say, a digital signal processing core, or in a combination of the two, for example, employing dedicated hardware to accelerate matrix operations. Generally, however, display drive processor 506 will be at least partially implemented by means of stored program code or micro code stored in a program memory 507, operating under control of a clock 508 and in conjunction with working memory 504. For example the display drive processor may be implemented using a standard digital signal processor and code written in a conventional programming language. The code in program memory 507 is configured to implement either line-by-line raster scanning of the display or a multi-line addressing method, in either case with adjustable line or sub-frame duration as described above, and may be provided on a data carrier or removable storage 507a.

FIG. 5b illustrates row and column drivers suitable for driving display 302 with a variable reference current so that, for example, the red/green/blue reference current may be varied in proportion to a variation in line or sub-frame “scan” time. The illustrated drivers are also suitable for driving display 302 with factorised image matrix data in an MLA scheme.

The column drivers 510 comprise a set of adjustable substantially constant current sources 1002 which are ganged together and provided with a variable reference current I_{ref} for setting the current into each of the column electrodes. This reference current is pulse width modulated by a different value for each column derived from a row of a factor matrix such as row a of matrix F of FIG. 4e.

The row drivers 512 comprise a programmable current mirror 1012, preferably with one output for each row of the display or for each row of a block of simultaneously driven rows. The row drive signals are derived from a column of a factor matrix such as column a of matrix G of FIG. 4e. Further details of suitable drivers can be found in the Applicant's co-pending UK patent application no. 0421711.3 filed on 30 Sep. 2004, hereby incorporated by reference. In other arrangements other means of varying the drive to an OLED pixel, in particular PWM, may additionally or alternatively employed.

No doubt many effective alternatives will occur to the skilled person. For example display drive logic 506 may be implemented using a microprocessor under software control rather than in dedicated logic, or a combination of a microprocessor and dedicated logic may be employed. Where a microprocessor is employed buses 502 and 505 may be combined in a shared address/data/control bus, although again frame memory 504 is preferably dual-ported to simplify interfacing the display to other devices.

It should be understood that the invention is not limited to the described embodiments but encompasses modifications apparent to those skilled in the art lying within the spirit and scope of the claims appended hereto.

1. A method of driving a passive matrix multicolor electroluminescent display, the display comprising a plurality of pixels arranged in rows and columns, each said pixel comprising at least first and second sub-pixels having different respective first and second colors, the method comprising:
driving groups of said pixels in turn to display a multicolor image frame, said driving of a group of pixels comprising driving first and second sub-groups of sub-pixels of respective said first and second colors; and
wherein said driving further comprises driving a said group of pixels for a duration dependent upon a maximum drive level of a sub-pixel of a said sub-group.

2. A method as claimed in claim 1 wherein said driving of groups of pixels to display an image frame comprises driving over a frame period, wherein said frame period is divided into periods for driving each said group of pixels in proportion to said maximum drive level of said sub-group for each said group of pixels, and wherein said driving comprises driving said groups of pixels according to said frame period divisions.

3. A method as claimed in claim 1 wherein said colors include blue, and wherein said duration is dependent upon a maximum drive level of a sub-group of blue sub-pixels of a group of pixels.

4. A method as claimed in claim 1 wherein said colors include red, and wherein said duration is dependent upon a maximum drive level of a sub-group of red sub-pixels of a group of pixels.

5. A method as claimed in claim 1 wherein said duration is dependent upon a weighted combination of a maximum drive level of a first sub-pixel of said first sub-group and of a maximum drive level of a second sub-pixel of said second sub-group.

6. A method as claimed in claim 5 wherein said driving of groups of pixels to display an image frame comprises driving over a frame period, wherein said frame period is divided into periods for driving each said group of pixels in proportion to said weighted combination for each said group of pixels, and wherein said driving comprises driving said groups of pixels according to said frame period divisions.

7. A method as claimed in claim 1 further comprising adjusting a drive to a said sub-group of sub-pixels responsive to said duration of driving for the said sub-group.

8. A method as claimed in claim 1 wherein a said group of pixels comprises a said row or column of said display; and wherein said driving comprises row-by-row or column-by-column driving of said display.

9. A method as claimed in claim 1 wherein a said group of pixels comprises a temporal sub-frame of said display including pixels in a plurality of rows and a plurality of columns of the display; and wherein said driving comprises driving said display with a plurality of said temporal sub-frames in succession.

10. A method as claimed in claim 1 wherein said display comprises an organic light emitting diode display.

11. A carrier carrying processor control code to implement the method of claim 1.

12. A driver for a passive matrix multicolor electroluminescent display, the display comprising a plurality of pixels arranged in rows and columns, each said pixel comprising at least first and second sub-pixels having different respective first and second colors, the driver comprising:
means for driving groups of said pixels in turn to display a multicolor image frame, said driving of a group of pixels comprising driving first and second sub-groups of sub-pixels of respective said first and second colors; and
means for driving a said group of pixels for a duration dependent upon a maximum drive level of a sub-pixel of a said sub-group.

13. A driver for passive matrix multicolor electroluminescent display, the display comprising a plurality of pixels arranged in rows and columns, each said pixel comprising at least first and second sub-pixels having different respective first and second colors, the driver comprising:
a data input to receive image data for display;
a display drive system, coupled to said data input and having a display drive output for driving said display, said display drive system being configured to output display drive signals for driving groups of said pixels in turn to display a multicolor image frame, said driving of a group of pixels comprising driving first and second sub-groups of sub-pixels of respective said first and second colors; and
a drive time computation system, coupled to said display drive system, said drive time computation system being configured to control said display drive system to drive a said group of pixels for a duration dependent upon a maximum drive level of a sub-pixel of a said sub-group.

14. A method of driving an electroluminescent display having a plurality of pixels arranged in rows and columns, the method comprising driving the display with successive sets of row and column signals to build up a displayed image, each set of signals defining a sub-frame of the displayed image in which pixels in a plurality of rows and columns of the display are driven simultaneously, the sub-frames combining to create said displayed image, the method further comprising driving said display with a said set of signals for a sub-frame for a duration dependent upon a maximum drive level of a pixel of the sub-frame.

15. A carrier carrying processor control code to implement the method of claim 14.

16. A driver for driving an electroluminescent display having a plurality of pixels arranged in rows and columns, the driver comprising:
a data input to receive image data for display;
a display drive system, coupled to said data input and having a display drive output for driving said display, said display drive system being configured to output display drive signals for driving the display with successive sets of row and column signals to build up a displayed image, each set of signals defining a sub-frame of the displayed image in which pixels in a plurality of rows and columns of the display are driven simultaneously, the sub-frames combining to create said displayed image; and
a drive time computation system, coupled to said display drive system, said drive time computation system being configured to control said display drive system to drive said display with a said set of signals for a sub-frame for a duration dependent upon a maximum drive level of a pixel of the sub-frame.
